(19) United States
(12) Patent Application Publication
(10) Pub. No.: US 2003/0087052 A1
(43) Pub. Date: May 8, 2003

(54) Spoolable composite tubing with a catalytically cured matrix

(76) Inventors: Thomas W. Wideman, Milton, MA (US); Peter A. Quigley, Duxbury, MA (US); Stephen C. Nolet, Franklin, MA (US); Michael Feechan, Sagamore, MA (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/288,600

(22) Filed: Nov. 5, 2002

Related U.S. Application Data
(60) Provisional application No. 60/337,242, filed on Nov. 5, 2001.

(51) Int. Cl. B32B 1/08

(52) U.S. Cl. 428/36.4; 138/153; 138/172; 428/36.91

(57) ABSTRACT

A spoolable composite tube and methods for making the same are provided for which comprises an inner liner and a composite layer which comprises fibers. The fibers may be embedded in a catalytically cured matrix. The catalytically cured matrix may include polymers comprising ether moieties.

### RELATED APPLICATION INFORMATION

This application claims the benefit of priority to Provisional Patent Application 60/337,242, filed Nov. 5, 2001, which is hereby incorporated by reference in its entirety.

### BACKGROUND

Certain properties of the composite matrix material are desirable during the manufacturing operations of high strength fiber reinforced pipe by continuous processes. These processes include filament winding, pultrusion, braiding, or centrifugal casting. The desirable properties of the matrix may include low viscosity, stability at room temperature, controllable gel time and thermal chemorheology, low flammability, low toxicity, compatibility with other materials in the tubing, and compatibility with the materials, processes and equipment used in the manufacturing operations. Other properties may be required in the final product, such as controllable modulus, maximum stress, maximum strain, glass transition temperature, heat deflection temperature, combined thermomechanical properties, toughness, low void content, chemical and solvent resistance, and UV resistance. Many of these properties may be dependent on a high degree of cure of the matrix material.

In the manufacture of parts of discrete length, such as sectional, jointed, or discontinuous tubing, these properties, especially the high degree of cure, can be achieved using matrix systems that require extensive curing operations to reach their optimum performance. The composite parts may be quickly gelled in the winding, pultrusion, or centrifugal casting operation, and then given the complete cure in a separate operation which is off-line from the fabrication operation, thereby not limiting the speed of the overall manufacturing process. Continuous composite tubing, however, is usually limited by a curing process which must take place in-line with the fabrication or manufacturing process. Consequently, the overall output of the manufacturing may be limited by the time needed for complete cure of the matrix and the length of the curing operation. In practice, there are limits to the length of the equipment used in curing operation. A further manufacturing challenge is that spoolable composite pipe is wound onto reels or is coiled for transport, and this necessitates that the matrix also have higher strain to failure compared to many other matrix systems used in sectional, jointed, or discontinuous composite pipe. For at least these reasons, there is a need for matrix systems for the manufacture of composite spoolable tubes that allow for short cure times, suitable physical, mechanical and thermal properties with ease of processing.

### SUMMARY

In accordance with one exemplary embodiment, a composite tube includes an inner liner and a composite layer of fibers embedded in a catalytically cured matrix surrounding the internal liner. In certain embodiments, the inner liner is substantially fluid impervious.

The catalytically cured matrix may be a polymer having a plurality of ether moieties in the backbone chain of the polymer. In certain embodiments, the catalytically cured matrix may be a thermoset resin. The catalytically cured matrix maybe, for example, a catalytically cured epoxy resin.

The catalytically cured thermoset resin may be, for example, a thermosetting resin cured with a metal complex, wherein the metal complex is selected from formulas MLₓB_{y}, M[AI]ₓB_{z}, and MLₓB_{y}[AI]_{z}; and wherein

M is a metal;

L is chelate forming ligand;

AI is an acid ion of an inorganic acid;

B is a Lewis base;

x is a number from 1 to about 8;

y is a number from 1 to about 8; and

z is a number from 1 to about 8.

In one embodiment, a method is provided for making a spoolable composite tube, where the method includes providing a tube comprising a liner and forming a composite layer enclosing the liner, wherein the composite layer is formed on the liner by applying fibers to the liner; applying a thermosetting polymer comprising a catalytic agent to the liner, and curing the composite layer.

### BRIEF DESCRIPTION OF THE DRAWINGS

These and other features and advantages of the composite tube disclosed herein will be more fully understood by reference to the following detailed description in conjunction with the attached drawings in which like reference numerals refer to like elements through the different views. The drawings illustrate principles of the composite tubes disclosed herein and, although not to scale, show relative dimensions.

FIG. 1 is a perspective view, partially broken away, of an exemplary composite tube including an interior liner and a composite layer; and

FIG. 2 is a side view in cross-section of the composite tube of FIG. 1.

### DETAILED DESCRIPTION OF EXEMPLARY EMBODIMENTS

### Definitions

For convenience, before further description, certain terms employed in the specification, examples, and appended claims are collected here. These definitions should be read in light of the reminder of the disclosure and understood as by a person of skill in the art.

The articles “a” and “an” are used herein to refer to one or to more than one (i.e. to at least one) of the grammatical object of the article. By way of example, “an element” means one element or more than one element.

The term “aliphatic” is an art-recognized term and includes linear, branched, and cyclic alkanes, alkenes, or alkynes. In certain embodiments, aliphatic groups in the present invention are linear or branched and have from 1 to about 20 carbon atoms.

The term “alkyl” is art-recognized, and includes saturated aliphatic groups, including straight-chain alkyl groups, branched-chain alkyl groups, cycloalkyl (alicyclic) groups, alkyl substituted cycloalkyl groups, and cycloalkyl substituted alkyl groups. In certain embodiments, a straight chain or branched chain alkyl has about 30 or fewer carbon atoms in its backbone (e.g., C₁-C₃₀ for straight chain, C₃-C₃₀ for branched chain), and alternatively, about 20 or fewer. Likewise, cycloalkyls have from about 3 to about 10 carbon atoms in their ring structure, and alternatively about 5, 6 or 8 carbons in the ring structure.

Moreover, the term “alkyl” (or “lower alkyl”) includes both “unsubstituted alkyls” and “substituted alkyls”, the latter of which refers to alkyl moieties having substituents replacing a hydrogen on one or more carbons of the hydrocarbon backbone. Such substituents may include, for example, a halogen, a hydroxyl, a carbonyl (such as a carboxyl, an alkoxycarbonyl, a formyl, or an acyl), a thiocarbonyl (such as a thioester, a thioacetate, or a thioformate), an alkoxyl, a phosphoryl, a phosphonate, a phosphinate, an amino, an amido, an amidine, an imine, a silyl, a cyano, a nitro, an azido, a sulfhydryl, an alkylthio, a sulfate, a sulfonate, a sulfamoyl, a sulfonamido, a sulfonyl, a heterocyclyl, an aralkyl, or an aromatic or heteroaromatic moiety. It will be understood by those skilled in the art that the moieties substituted on the hydrocarbon chain may themselves be substituted, if appropriate. For instance, the substituents of a substituted alkyl may include substituted and unsubstituted forms of amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF₃, —CN and the like. Exemplary substituted alkyls are described below. Cycloalkyls may be further substituted with alkyls, alkenyls, alkoxys, alkylthios, aminoalkyls, carbonyl-substituted alkyls, —CF₃, —CN, and the like.

The term “aralkyl” is art-recognized, and includes alkyl groups substituted with an aryl group (e.g., an aromatic or heteroaromatic group).

The terms “alkenyl” and “alkynyl” are art-recognized, and include unsaturated aliphatic groups analogous in length and possible substitution to the alkyls described above, but that contain at least one double or triple bond respectively.

Unless the number of carbons is otherwise specified, “lower alkyl” refers to an alkyl group, as defined above, but having from one to ten carbons, alternatively from one to about six carbon atoms in its backbone structure. Likewise, “lower alkenyl” and “lower alkynyl” have similar chain lengths.

The term ‘chelate forming ligand’ refers to an organic molecule which binds a metal ion or atom to form a ring or ring-like structure.

The term ‘curing’ is an art recognized term which refers to a chemical process of converting a monomer, oligomer, prepolymer or a polymer in a viscous or solid state into a product in which the monomer, oligomer, polymer or prepolymer attains higher molecular mass or becomes a network.

The term “heteroatom” is art-recognized, and includes an atom of any element other than carbon or hydrogen. Illustrative heteroatoms include boron, nitrogen, oxygen, silicon, phosphorus, sulfur and selenium, and alternatively oxygen, nitrogen or sulfur.

The term “aryl” is art-recognized, and includes 5-, 6- and 8-membered single-ring aromatic groups that may include from zero to four heteroatoms, for example, benzene, pyrrole, furan, thiophene, imidazole, oxazole, thiazole, triazole, pyrazole, pyridine, pyrazine, pyridazine and pyrimidine, and the like. Those aryl groups having heteroatoms in the ring structure may also be referred to as “aryl heterocycles” or “heteroaromatics.”The aromatic ring may be substituted at one or more ring positions with such substituents as described above, for example, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, or the like. The term “aryl” also includes polycyclic ring systems having two or more cyclic rings in which two or more carbons are common to two adjoining rings (the rings are “fused rings”) wherein at least one of the rings is aromatic, e.g., the other cyclic rings may be cycloalkyls, cycloalkenyls, cycloalkynyls, aryls and/or heterocyclyls.

The terms “heterocyclyl” and “heterocyclic group” are art-recognized, and include 3- to about 10-membered ring structures, such as 3- to about 8-membered rings, whose ring structures include one to four heteroatoms. Heterocycles may also be polycycles. Heterocyclyl groups include, for example, thiophene, thianthrene, furan, pyran, isobenzofuran, chromene, xanthene, phenoxathiin, pyrrole, imidazole, pyrazole, isothiazole, isoxazole, pyridine, pyrazine, pyrimidine, pyridazine, indolizine, isoindole, indole, indazole, purine, quinolizine, isoquinoline, quinoline, phthalazine, naphthyridine, quinoxaline, quinazoline, cinnoline, pteridine, carbazole, carboline, phenanthridine, acridine, pyrimidine, phenanthroline, phenazine, phenarsazine, phenothiazine, furazan, phenoxazine, pyrrolidine, oxolane, thiolane, oxazole, piperidine, piperazine, morpholine, lactones, lactams such as azetidinones and pyrrolidinones, sultams, sultones, and the like. The heterocyclic ring may be substituted at one or more positions with such substituents as described above, as for example, halogen, alkyl, aralkyl, alkenyl, alkynyl, cycloalkyl, hydroxyl, amino, nitro, sulfhydryl, imino, amido, phosphonate, phosphinate, carbonyl, carboxyl, silyl, ether, alkylthio, sulfonyl, ketone, aldehyde, ester, a heterocyclyl, an aromatic or heteroaromatic moiety, —CF₃, —CN, or the like.

The terms “Lewis base” and “Lewis basic” are recognized in the art, and refer to a chemical moiety capable of donating a pair of electrons under certain reaction conditions. Examples of Lewis basic moieties include uncharged compounds such as alcohols, thiols, and amines, and charged moieties such as alkoxides, thiolates, carbanions, and a variety of other organic anions.

The terms “Lewis acid” and “Lewis acidic” are art-recognized and refer to chemical moieties which can accept a pair of electrons from a Lewis base as defined above.

The terms “polycyclyl” and “polycyclic group” are art-recognized, and include structures with two or more rings (e.g., cycloalkyls, cycloalkenyls, cycloalkynyls, aryls and/or heterocyclyls) in which two or more carbons are common to two adjoining rings, e.g., the rings are “fused rings”. Rings that are joined through non-adjacent atoms, e.g., three or more atoms are common to both rings, are termed “bridged” rings. Each of the rings of the polycycle may be substituted with such substituents as described above, as for example, halogen, alkyl, aralkyl, alkenyl, alkynyl, cycloalkyl, hydroxyl, amino, nitro, sulfhydryl, imino, amido, phosphonate, phosphinate, carbonyl, carboxyl, silyl, ether, alkylthio, sulfonyl, ketone, aldehyde, ester, a heterocyclyl, an aromatic or heteroaromatic moiety, —CF₃, —CN, or the like.

The term “carbocycle” is art recognized and includes an aromatic or non-aromatic ring in which each atom of the ring is carbon.

The following art-recognized terms have the following meanings: “nitro” means —NO₂; the term “halogen” designates —F, —Cl, —Br or —I; the term “sulfhydryl” means —SH; the term “hydroxyl” means —OH; the term silyl means —SiR₃ where R here can be H, C, O, halogen or heteroatom, and the term “sulfonyl” means —SO₂^{—}.

The terms “alkoxyl” or “alkoxy” are art-recognized and include an alkyl, aralkyl, aryl, heterocyclyl, polycyclyl, and carbocycle groups, as defined above, having an oxygen atom attached thereto. Representative alkoxyl groups include methoxy, ethoxy, propyloxy, tert-butoxy, benzyloxy, phenoxy, and the like. An “ether” is common chemical moiety in which two hydrocarbons are covalently linked through an oxygen.

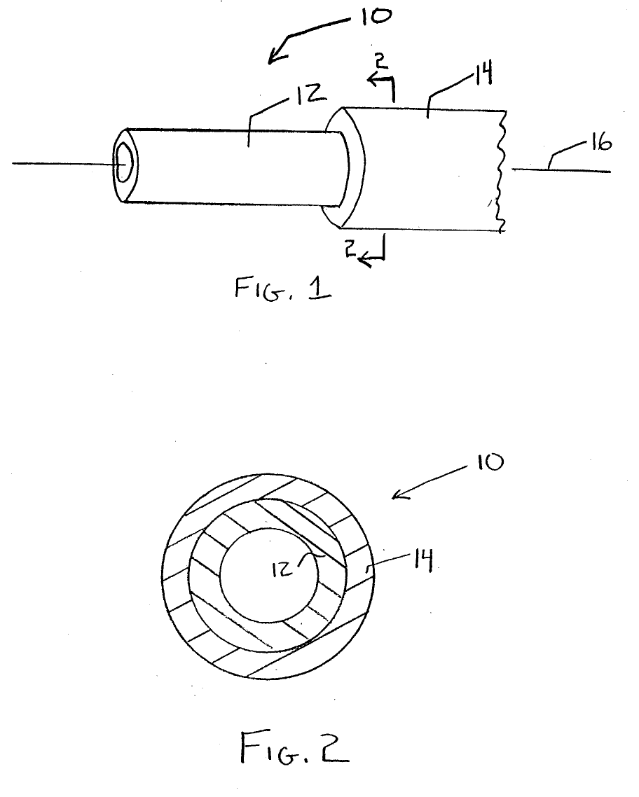

Referring to FIGS. 1-2, an exemplary composite tube 10 constructed of an inner liner 12, and a composite layer 14 is illustrated. The composite tube 10 is generally formed along a longitudinal axis 16 and can have a variety of cross-sectional shapes, including circular, oval, rectangular, square, polygonal, and the like. The illustrated tube 10 has a circular cross-section. The composite tube 10 can generally be constructed in manner analogous to one or more of the composite tubes described in commonly owned U.S. Pat. No. 6,016,845, U.S. Pat. No. 5,921,285, U.S. Pat. No. 6,148,866, and U.S. Pat. No. 6,004,639. Each of the aforementioned patents is incorporated herein by reference.

The liner 12 serves as a fluid containment and gas barrier member to resist leakage of internal fluids from the composite tube 10. The liner 12 may be constructed from polymeric materials such as thermoplastics and thermoset polymers, but may also be elastomeric or metallic or a heat-shrinkable material. The liner 12 may also include fibers or additives to increase the load carrying strength of the liner and the overall load carrying strength of the composite tube.

The composite layer 14 can be formed of one or more plies, each ply having one or more fibers disposed within a catalytically cured matrix, such as a polymer, or resin. The matrix may have a tensile modulus of elasticity of at least about 690 MPa (100,000 psi) and a glass transition temperature of at least about 50° C., or at least about 82° C. (180° F.). In addition, the matrix may have a maximal tensile elongation greater than or equal to about 2%. The tensile modulus rating and the tensile elongation rating are generally measured at approximately 20° C. (68° F.). The fiber material and orientation can be selected to provide the desired mechanical characteristics for the composite layer 14 and the composite tube 10. Additional composite layers or other layers beyond the composite layer 14, such as a wear resistant layer or a pressure barrier layer, may also be provided interior or exterior to the composite layer to enhance the capabilities of the composite tube 10. Additional optional layers may include a thermal insulation layer to maintain the temperature of fluid carried by the composite tube 10 within a predetermined temperature range, a crush resistant layer to increase the hoop strength of the composite tube, and/or a layer of low density or high density material to control the buoyancy of selected lengths of the composite tube. Composite tubes including such optional layers are described in commonly-owned U.S. Ser. No. 10/134,971, hereby incorporated by reference. Moreover, the composite tube may include one or more optional permeation or diffusion barriers and optional adhesive layers for bonding to the permeation or diffusion barrier to another layer of the composite tube. Composite tubes including permeation or diffusion barriers, adhesive layers, additional optional features for controlling the permeation of fluids through the walls of the composite tube are disclosed in commonly owned U.S. Provisional Application No. 60/337,848 filed Nov. 5, 2001, hereby incorporated by reference.

The composite tube 10 may optionally include one or more energy conductors within the composite tube. In addition, sensors optionally may be provided within the composite tube 10 to monitor the condition of the tube and/or conditions of the fluid transported by the composite tube 10.

The catalytically cured matrix may be a polymer having a plurality of ether moieties in the polymer backbone chain, or a polymer with primarily a polyether structure. Exemplary catalytically cured matrices include polymers which may have a plurality of units represented by formula I:

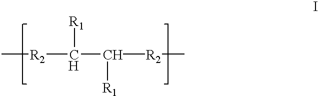

where R₁ and R₂ may each independently selected from the group consisting of alkyl, alkenyl, alkynyl, alkoxy, hydroxyl, aralkyl, aryl, heterocyclyl, polycyclyl, carbocycles, heteroatoms, halogens, and hydrogen. The catalytically cured matrix may have units of the above structure which are repeated in sequence, in blocks, separated by other units, or in any other pattern or random arrangement. The catalytically cured matrix may encompass a variety of different polymer structures, including block copolymers, random copolymers, random terpolymers and segmented block copolymers and terpolymers.

An exemplary catalytically cured matrix may be a polymer with a plurality of a units represented by structures II or III:

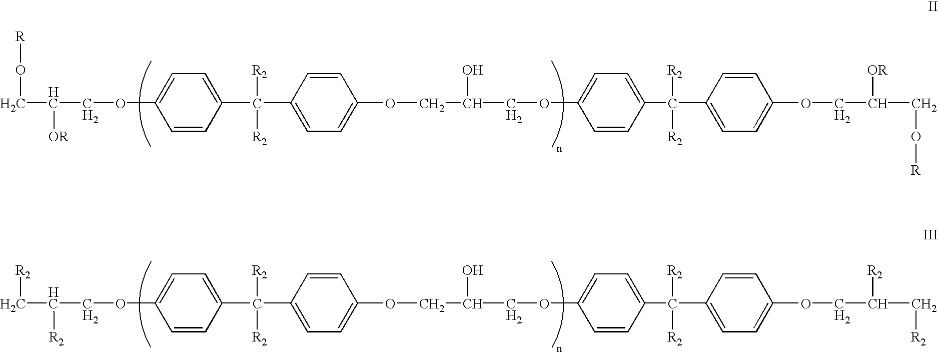

where R may be independently selected from hydrogen, alkyl, aralkyl or aryl; R₂ may be independently selected from hydrogen, alkyl, aralkyl, aryl, hydroxyl, or alkoxyl, and n may be 0 to about 20, or even about 0 to about 5.

The catalytically cured matrix may also include other additives and the like such as moieties of the catalytic agent, toughening agents, flexibilizers, stabilizers, diluents, flame retardants, thixotropes, impurities, fillers, extenders, and other co-catalysts or accelerators.

Toughening agents include a thermoplastic polymers or a reactive rubbers. Exemplary thermoplastic polymers include hydroxyl containing thermoplastic oligomers, epoxy containing thermoplastic oligomers, elastomers, polyetherimide, polyethersulphone, and polycarbonate. Reactive rubbers include for example, butylnitrile rubber with various terminal groups such as carboxylate and amine, a terminated polybutadiene/acrylonitrile rubber with various terminal groups such a carboxylate and amine, epoxidized castor oil, and acrylate co-polymers. Toughening agents may also include silicones, silicon rubber dispersions, highly crosslinked powdered nitrile rubbers, (meth)acrylate core/shell rubbers, flexibizers, plasticizers, and reactive diluents, such as for example mono- or di-functional aliphatic epoxy flexibilizers, acrylates, methacrylates, and glycidyl ethers.

Other optional additives to the matrix include UV stabilizers, flame retardants, antioxidants, thixotropic agents, stabilizing agents, fillers, binding agents, extenders, thinners, accelerating additives, and various other processing aids such as wetting agents, anti-foaming agents, release agents, and dispersing agents, all of which are known and commonly used in the art.

The catalytically cured matrix may be formed by reacting a thermosetting polymer such as an epoxy resin with a catalytic agent on a tubular liner. Fibers may be applied on the tubular liner by a continuous winding process, for example the process described in U.S. Pat. No. 6,016,845, U.S. Pat. No. 5,921,285, U.S. Pat. No. 6,148,866, and U.S. Pat. No. 6,004,639. A thermosetting polymer comprising a catalytic agent may be applied to a tubular lining using any known method in the art. Alternatively, a thermosetting polymer may be applied to a tubular lining, and separately a catalytic agent may applied to the lining. The composite layer on the tubular liner may be formed by curing the thermosetting polymer with the embedded fibers.

Catalytic curing agents may be characterized as being used substoichiometrically in the cure of epoxies. They may be used in less than about 0.005:1, or less than about 0.5:1 ratio of catalyst to epoxide groups, and in one embodiment, with a ratio of about 0.05:1. This may differ from anhydride or amine cured epoxies where the ratio of primary reactive functionalities is usually above about 0.8:1 and may be about 1:1 for amine curing agents.

The catalytic curing agent may also be characterized by causing primarily the direct linkage of epoxy molecules through the ring opening reaction of the epoxide group. This may differ from anhydride and amine curing agents which react by polyaddition reactions to form an polymer with a plurality of curing agent-epoxy linkages.

Epoxy resins may contain an epoxide, oximine or ethoxylene moiety. The epoxy resin may be a glycidyl epoxy or an non-glycidyl epoxy resin. Exemplary non-glycidyl epoxies include aliphatic or cycloaliphatic epoxy resins. Glycidyl epoxies include glycidyl-ether, glycidyl-ester, and glycidyl amine epoxies.

Epoxide resins or compounds may include all epoxide compounds with one or more epoxide moiety, for example, polyphenol-glycidyl ethers, epoxidized novolacs or the reaction products of epichlorohydrin and Bisphenol A or Bisphenol F, as well as the diclycidyl ether of Bisphenol A and N,N,N′,N′-tetraglycidyldiaminodiphenyl methane.

Epoxy resins include epoxy resins based on, or derived from for example biphenyl bisphenol, multifunctional glycidol amines, derivatives of glycidoxy-para-amino phenol, liquid crystal structures, for example α-methyl stilbene, structures derived from naphthalene, for example 2,5 isomers of dihydroxy naphthalene, hydroxyphenyl methane, and hydroxyphenyl flourine. Other suitable epoxy resins include epoxy resins which are modified with other moieties or additives for example high T_{g} polyphenylene ether, bismaleimide-triazine resins, hydroxyl functional polyarylsulfone, amine functional polyarylsulfone, acrylic polymers including dispersion, emulsion or core/shell rubber polymers, butylnitrile rubber and silicon rubber. An epoxy resin may have an epoxide equivalent of about 100 to about 5000. The epoxy resins may be polymerized singly or in mixtures and optionally in the presence of solvents, and may be mixed with monoepoxides or other reactive diluents.

Catalytic agents which may be used to catalytically cure an epoxy resin include organic bases; inorganic anions; radical initiators, for example peroxides; halides of tin, aluminum, zinc, boron, silicon, iron, titanium, magnesium, antimony and their base adducts; tertiary amines and their adducts; metal alkoxides; metal hydroxides; alkyl-zinc compounds; borate and borates esters; aminooxadiazoles; pyrazines and pyradine derivatives; amine oxides; and alkoxyamines; imidazoles and derivatives of imidazoles; triazine derivatives; active hydrogen compounds including anhydrides, for example carboxylic acid anhydrides and amines; Lewis acids, for example BF₃, BCl₃, BF₃ methyl ethyl amine complexes and BF₃ ethyl amine complexes and adducts thereof; Lewis bases, including accelerated Lewis bases and metal complexes including catalysts such as bisurea accelerated dicyandiamide agents, piperdines and benzyl dimethyl amines; salts or adducts of catalytic curing agents, for example catalyst adducts with Lewis bases such as transition metal salts or compounds containing imidazole ligands. Catalytic curing agents also include compounds that generate said catalytic compounds in-situ upon exposure to heat, electromagnetic or particle radiation.

The catalytic agents may include a metal complex compound of the formula MLₓB_{y}, M[AI]ₓB_{z}, or MLₓB_{y}[AI]_{z} where M is a metal, or metal ion of any metal. The metal may be any metal selected from the main groups II and III and transition metals of the Periodic Table. L may be an adduct, a ligand, or a chelate forming ligand. Chelate forming ligands may be chiral with at least two electronically distinct donor centers. The chelate forming ligand may be selected from the group consisting of dioximes, α- and β hydroxycarbonyl compounds or an enolizable 1,3-diketones ligand. AI may be any acid ion of an inorganic acid, B may be any Lewis base, x may be a number from about 1 to about 8, y may be a number from about 1 to about 8 and z may be a number from about 1 to about 8. The metal or metal ions may include cobalt, nickel, iron, zinc or manganese ions.

The ligands may include chelate-forming ligands which are organic compounds containing at least two atom groups which act as electron donors such as dioximes, α- and β-hydroxycarbonyl compounds, enolizable 1,3-diketones, and cyclic ethers. Chelate ligands include acetyl acetone, benzoyl acetone or dipivaloyl methane malonic acid diesters or dinitriles, acetoacetic acid esters, cyanoacetic acid esters, nitromethane, aliphatic or aromatic carboxylic acid.

The acid ions (AI), may be any acid radical of an inorganic acid. The Lewis base (B) for the metal complex may be any nucleophilic molecules or ions with a lone electron pair. The Lewis base may be, for example, pyridine or imidazole compounds, ethers including cyclic ethers such as tetrahydrofuran, alcohols, ketones, thioethers or mercaptans.

Lewis bases may be in complexes of the formula MLₓB_{y}, but also as CH-acid compounds present as Lewis bases, i.e. CH-acid compounds in which one proton is split off. Examples of such CH-acid bases are CH acid pyridines or imidazoles.

The charge equalization of the metal cations of the metal complex compounds may take place through the ligands as well as through ionic Lewis bases, and therefore, the number of charge-carrying ligands may be reduced when the complex contains ionic Lewis bases.

The catalytic complexes may be CH-acid Lewis bases bound to a metal-chelate compound by nitrogen and/or oxygen and/or sulfur and/or phosphorus atoms or hydrogen bridges. These metal complex compounds may be obtained by the reaction of the respective metal salts with the desired ligands and Lewis bases.

Exemplary examples of catalytic metal complex compounds are the following metal complexes: bis(acetylacetonato)-cobalt-II-diimidazole, bis(acetylacetonato)-nickel-II-diimidazole, bis(acetylacetonato)-zinc-II-diimidazole, bis(acetylacetonato)-manganese-II-diimidazole, bis(acetylacetonato)-iron-II-diimidazole, bis(acetylacetonato)-cobalt-II-di(dimethylimidazole), bis(acetylacetonato)-cobalt-II-dibenzimidazole, bis(acetato)-cobalt-II-diimidazole, bis[2-ethylhexanato]-cobalt-II-diimidazole, and bis(salicylaldehydo)-cobalt-II-diimidazole.

The catalytic agents may be mixed with the epoxide compounds at a temperature and energy below the polymerization initiation temperature or energy of the matrix or composite, for example, mixed at a temperature in the range from about 25° C. to about 100° C. In this range, the mixtures may be storable and can be processed to molding or pouring compositions, adhesive mixtures or prepregs, or in the tubing manufacturing operation. Hardening of the epoxide compound, or curing, may then occur through an energy supply. The supply of energy can occur in the form of, for example, thermal energy, light, electromagnetic or particle radiation, induction, microwaves, or laser energy.

One advantage of the formation of the matrix via a catalytic cure may derive from the ability to dissolve the metal complex in the polymerizable epoxide compound or in the polymerizable epoxide mixture below the polymerization initiation temperature and energy. This may yield homogeneous polymer compositions. When using, for example, benzoylacetone or dipivaloylmethane as the ligand, the polymer compositions may be transparent. When using acid ions such as for example, sulfates, nitrates, halides, and phosphates, the polymer compositions can be colored. Moreover, no solvents may be needed to moderate the reactivity of the Lewis bases which means there may be no need for additional processing steps for the removal of the solvent. This may result in fewer quality-diminishing cavities formed in the polymer. Further, there may be no increased water absorption capacity of the polymer. When, for example, imidazole compounds, which may be poisonous, act as initiators no toxic action may be observable.

The splitting of the Lewis base metal compound, or curing, may take place at, in one embodiment, temperatures above room temperature, for example, above 50° C., or above 100° C., or between about 50° C. and about 300° C., or between about 200° C. and about 300° C., or even by addition of alternative forms of energy such as, for example, electromagnetic or particle radiation, induction, microwaves, and laser energy.

A precursor system consisting of monomers, oligomers, prepolymers, or polymers, and metal complex may be stored for any length of time below the polymerization initiation temperature or energy and can be shaped, being hardened only by reaching the initiation temperature or energy level. Use of the metal complexes with the polymerizable compound is possible with or without addition of further additives. The polymer mixtures therefore may be multivariable.

The start of polymerization, i.e. the initiation temperature or energy level, may be determinable by the selection of the metal ligands, the selection of the Lewis bases, or the selection of the acid ions. Complexes with anions may react at lower temperatures or energies than complexes with chelate ligands. The use of substituted Lewis bases, e.g. alkylated imidazoles, may also effect the initiation temperature and may be lower than with the use of non-alkylated imidazole as Lewis base. By suitable selection of the complexes according to type of ligands, Lewis bases and metal, the polymerization initiation temperature or energy may be varied in a wide range.

The polymerization of epoxide resins by using a catalyst of metal-complex compounds described above may achieve, in addition to optimum gelation times, a reduced water absorption capacity and acetone absorption as compared with the use of pure Lewis bases such as imidazole. In an embodiment, a precursor system consisting of monomers and metal complex may be shaped below the polymerization initiation temperature after a storage time of any length and are hardened only by the initiation temperature being reached, and that for the imidazole compounds acting as initiators, which in themselves are poisonous, no toxic effect is observable. With this solution, it becomes possible to produce cost-effective, ecophile and non-toxic latent epoxy resin compositions having optimum gelation times on the basis of metal complex compounds.

The invention now being generally described, it will be more readily understood by reference to the following examples which are included merely for purposes of illustration of certain aspects and embodiments of the present invention and are not intended to limit the invention.

### EXAMPLE 1

A matrix for fiber-reinforced tubing was prepared using a bisphenol-A based epoxy, toughened with a silicone rubber, using 5% by weight of a salt of a zinc imidazole complex as a catalyst for the matrix material in a composite spoolable pipe. This mixed material has a mixed viscosity of 22000 cps (Brookfield), a pot life (time to double the viscosity) of several weeks at 70° F., and processes at 280° F. in less than 15 minutes to a least 95% cure. The cured matrix has a tensile modulus of 450 ksi, a maximum stress of 5-10 ksi, a glass transition temperature T_{g} of 320° F., and a tensile strain to failure of 4%.

### EXAMPLE 2

A matrix for fiber reinforced tubing was prepared with a mix ratio of 100:5 ppw Bisphenol-A epoxy resin:metal-imidazole salt catalyst. The matrix has a mix viscosity of 10000 cps, a pot life of days to weeks, and a cure schedule of 280° F. for 15 minutes with a 95% degree of cure. The matrix has a tensile modulus of 433 ksi and a tensile strength of 8 ksi, and a strain to failure of 2.4%. The glass transition temperature (T_{g}) was 340° F. The matrix has the toughness properties K_{1C} (MPa·m^{½})=0.65 and G_{1C} (J/m²)=114.

### EXAMPLE 3

A matrix for fiber-reinforced tubing was prepared from bisphenol-A based epoxy, with difunctional aliphatic epoxy flexibilizers, catalytically cured with 2,4 ethylmethyl imidazole. This material has a mixed viscosity of 10,000 cps, a pot life of 8 hours at 70° F., and processes at 350° F. for not more than 15 minutes to a least 95% cure. The cured matrix has a tensile modulus of 400 kpsi (690 MPa), a maximum stress of 10 kpsi, a glass transition temperature T_{g} of 350° F. (82° C.), and a tensile strain to failure of 3%.

### INCORPORATION BY REFERENCE

All patents, published patent applications and other references disclosed herein are hereby expressly incorporated herein in their entireties by reference. In case of conflict, the present application, including any definitions herein, will control.

### EQUIVALENTS

Those skilled in the art will recognize, or will be able to ascertain using no more than routine experimentation, that the composite tubes and methods of making them described above may be modified without departing from the broad inventive concept described herein. Thus, the invention is not to be limited to the particular embodiments disclosed herein, but is intended to cover modifications within the spirit and scope of the present invention as defined by the appended claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

1. A spoolable composite tube, comprising:
an inner liner; and
a composite layer enclosing said liner, wherein said composite layer comprises fibers embedded in a catalytically cured matrix.

2. The spoolable composite tube of claim 1, wherein said catalytically cured matrix is a polymer comprising ether moieties in a backbone chain of said polymer.

3. The spoolable composite tube of claim 1, wherein said catalytically cured matrix is a catalytically cured thermoset resin.

4. The spoolable composite tube of claim 3, wherein said catalytically cured thermoset resin is a catalytically cured epoxy resin.

5. The spoolable composite tube of claim 1, wherein said fibers may be independently selected from the group consisting of glass and carbon.

6. The spoolable composite tube of claim 1, wherein said composite layer comprises a first ply and a second ply, wherein said first ply comprises a first set of fibers and said second ply comprises a second set of fibers, wherein said first set and said second set are substantially different.

7. The spoolable composite tube of claim 6, wherein said first set of fibers are glass and said second set of fibers are carbon.

8. The spoolable composite tube of claim 1, wherein said inner liner is substantially fluid impervious.

9. The spoolable composite tube of claim 3, wherein said catalytically cured thermoset resin is a metal complex cured thermoset resin, wherein said metal complex is selected from formulas MLₓB_{y}, M[AI]ₓB_{z}, and MLₓB_{y}[AI]_{z}; and wherein
M is a metal;
L is chelate forming ligand;
AI is an acid ion of an inorganic acid;
B is a Lewis base;
x is a number from 1 to about 8;
y is a number from 1 to about 8; and
z is a number from 1 to about 8.

10. The spoolable composite tube of claim 9, wherein said metal is selected from the group consisting of cobalt, nickel, iron, zinc, and manganese.

11. The spoolable composite tube of claim 9, wherein said Lewis base is selected from the group consisting of pyridines, imidazoles, tetrahydrofuran, alcohols, ketones, thioethers and mercaptans.

12. The spoolable composite tube of claim 1, wherein said catalytically cured matrix has a tensile modulus of elasticity of at least about 400 kpsi.

13. The spoolable composite tube of claim 1, wherein said catalytically cured matrix has a glass transition temperature of at least about 350° F.

14. The spoolable composite tube of claim 1, wherein said catalytically cured matrix further comprises a toughening agent.

15. The spoolable composite tube of claim 14, wherein said catalytically cured matrix further comprises one or more of the group selected from UV stabilizers, flame retardants, antioxidants, thixotropic agents, stabilizing agents, pigments, and binding agents.

16. A method for making a spoolable composite tube, comprising:
providing a tubular liner, and forming a composite layer on said liner by:
applying fibers on said liner;
applying a thermosetting polymer comprising a catalytic agent on said liner; and
curing said composite layer.

17. The method of claim 16, wherein said thermosetting polymer is an epoxy resin.

18. The method of claim 17, wherein said epoxy resin comprises bisphenol A.

19. The method of claim 16, wherein said catalytic agent is a metal complex is selected from formulas MLₓB_{y}, M[AI]ₓB_{z} and MLₓB_{y}[AI]_{z}; and wherein
M is a metal;
L is chelate forming ligand;
AI is an acid ion of an inorganic acid;
B is a Lewis base;
x is a number from 1 to about 8;
y is a number from 1 to about 8; and
z is a number from 1 to about 8.

20. The method of claim 19, wherein said metal is selected from the group consisting of cobalt, nickel, iron, zinc, and manganese.

21. The method of claim 19, wherein said Lewis base is selected from the group consisting of pyridines, imidazoles, tetrahydrofuran, alcohols, ketones, thioethers and mercaptans.

22. The method of claim 17, wherein said catalytic agent is between about 0.005 and about 0.5 parts by weight of said epoxy resin.

23. The method of claim 22, wherein said catalytic agent is between about 0.01 and about 0.05 parts by weight of said epoxy resin.

24. The method of claim 16, wherein said catalytic agent is applied below a polymerization initiation temperature of said polymer.

25. The method of claim 24, wherein said curing comprises heating said tube at temperature of above about 50° C.

26. The method of claim 24, wherein said curing comprises heating said tube at a temperature of above 100° C.

27. The method of claim 16, wherein said thermoset polymer further comprises a toughening agent.

28. A spoolable composite tube, comprising:
an inner liner; and
a composite layer enclosing said liner, wherein said composite layer comprises a polymer comprising a plurality of ether moietes in the backbone chain of said polymer.
